(19) United States
(12) Patent Application Publication
(10) Pub. No.: US 2012/0091816 A1
(43) Pub. Date: Apr. 19, 2012

(54) POWER SYSTEMS WITH MULTIPLE POWER SOURCES

(75) Inventors: Da LIU, Milpitas, CA (US); Sheng-Tai LEE, Taipei (TW); Ju-Yuan HSIAO, Taipei (TW); Chang-Yi LIN, Taipei (TW)

(73) Assignee: O2MICRO, INC., Santa Clara, CA (US)

(21) Appl. No.: 13/289,364

(22) Filed: Nov. 4, 2011

Related U.S. Application Data
(60) Provisional application No. 61/413,578, filed on Nov. 15, 2010.

(51) Int. Cl. H02J 7/00

(52) U.S. Cl. 307/80

(57) ABSTRACT

In one embodiment, a power system includes a first power source having a first voltage, a second power source having a second voltage, and a controller. The controller is coupled to the first power source and the second power source. The controller compares the first voltage with the second voltage, controls the first power source to charge the second power source via a first switch and a second switch in a charging mode when the first voltage is greater than said second voltage, and controls the second power source to power a load such as a light-emitting diode (LED) light source via the second switch and a third switch in a load-powering mode when the second voltage is greater than the first voltage.

### RELATED APPLICATION

This application claims priority to U.S. Provisional Application No. 61/413,578, titled “Power Systems with Multiple Power Sources,” filed on Nov. 15, 2010, which is hereby incorporated by reference in its entirety.

### BACKGROUND

FIG. 1 shows a block diagram of a conventional power system 100 which includes a first power source, e.g., an adapter 102, and a second power source, e.g., a battery 110. The power system 100 further includes a direct-current to direct-current (DC/DC) converter 104, a charger 106, a switch 103, a switch 105, and a load, e.g., a light-emitting diode (LED) 108. The adapter 102 can be coupled to an AC power source (e.g., a 120V commercial power supply) and convert an AC voltage from the AC power source to a DC voltage V_{AD}.

In operation, when the switch 103 is turned on and the switch 105 is turned off, the power system 100 operates in a battery charging process. The adapter 102 delivers the DC voltage V_{AD} to charge the battery 110 and can also power the LED 108. The charger 106 provides proper charging power to the battery 110. The DC/DC converter 104 receives the DC voltage V_{AD} and provides the LED 108 with regulated power. When the switch 105 is turned on and the switch 103 is turned off, the battery 110 provides power to the LED 108 via the DC/DC converter 104.

However, there are two power chains in the power system 100. One power chain includes the charger 106, and the other includes the DC/DC converter 104. These two power chains increase the power consumption of the power system 100, thereby reducing the system power efficiency. These two power chains also increase the complexity of the power system 100. In addition, with the use of both the charger 106 and the DC/DC converter 104, the size of the printed circuit board (PCB) may be relatively large, which increase the cost of the power system 100.

### SUMMARY

In one embodiment, a power system includes a first power source having a first voltage, a second power source having a second voltage, and a controller. The controller is coupled to the first power source and the second power source. The controller compares the first voltage with the second voltage, controls the first power source to charge the second power source via a first switch and a second switch in a charging mode when the first voltage is greater than said second voltage, and controls the second power source to power a load such as a light-emitting diode (LED) light source via the second switch and a third switch in a load-powering mode when the second voltage is greater than the first voltage.

### BRIEF DESCRIPTION OF THE DRAWINGS

Features and advantages of embodiments of the subject matter will become apparent as the following detailed description proceeds, and upon reference to the drawings, wherein like numerals depict like parts, and in which:

FIG. 1 illustrates a block diagram of a conventional power system.

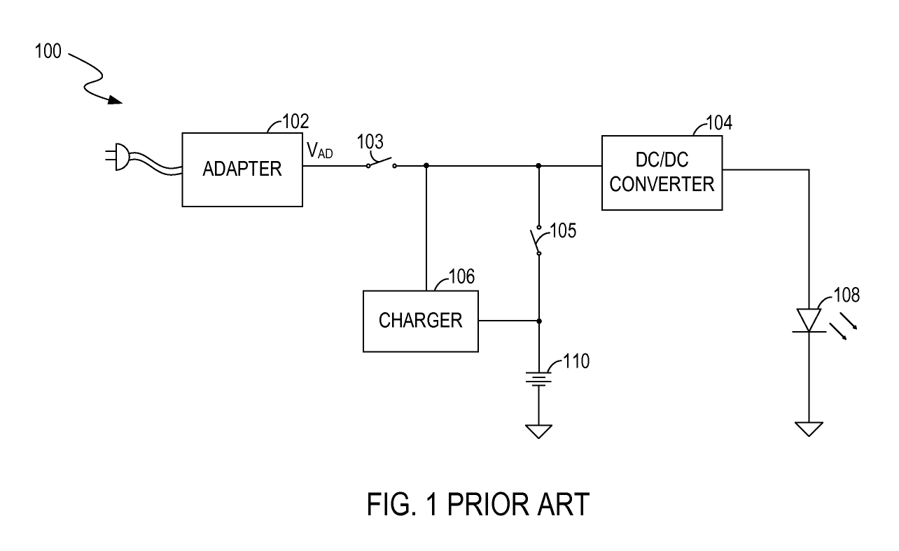

FIG. 2 illustrates a diagram of an example of a power system, in accordance with one embodiment of the present invention.

FIG. 2A illustrates an example of a diagram showing a relationship between an adjustable reference voltage V_{ADJ} and a voltage V_{UVLS} of the power system in FIG. 2, in accordance with one embodiment of the present invention.

FIG. 3A illustrates a timing diagram of examples of control signals of the power system in FIG. 2 in a charging mode.

FIG. 3B illustrates a timing diagram of examples of control signals of the power system in FIG. 2 in a load-powering mode.

FIG. 4 illustrates a diagram of an example of the control circuit 220 in the power system in FIG. 2, in accordance with one embodiment of the present invention.

FIG. 5 illustrates a timing diagram of examples of signals associated with a flip-flop in the control circuit 220 in FIG. 4, in accordance with one embodiment of the present invention.

FIG. 6 illustrates a flowchart of examples of operations performed by a power system, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

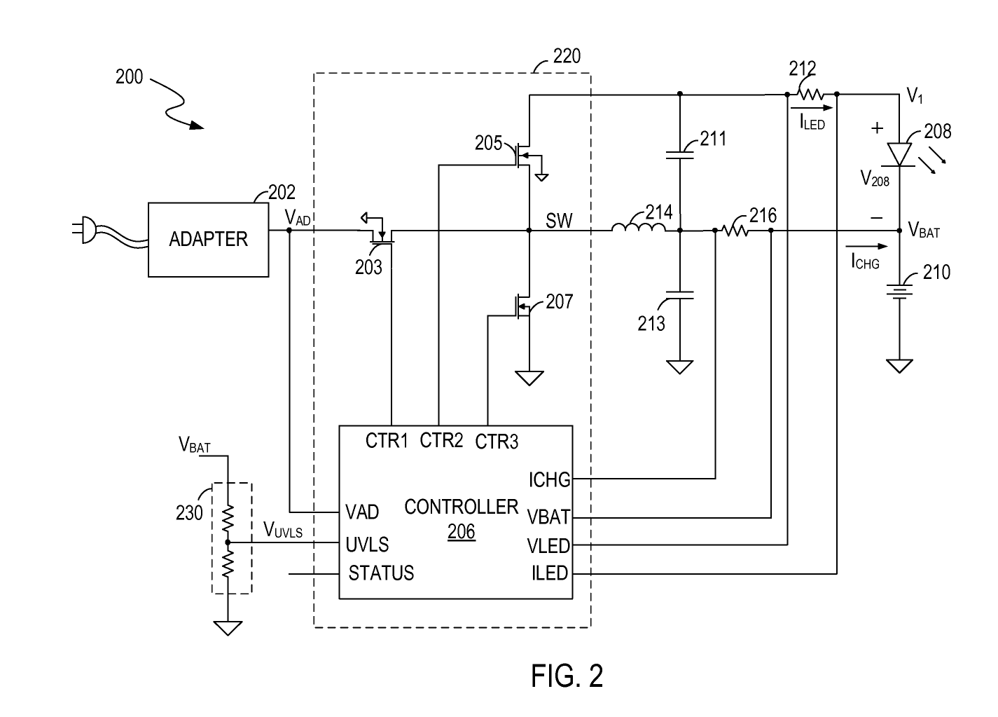

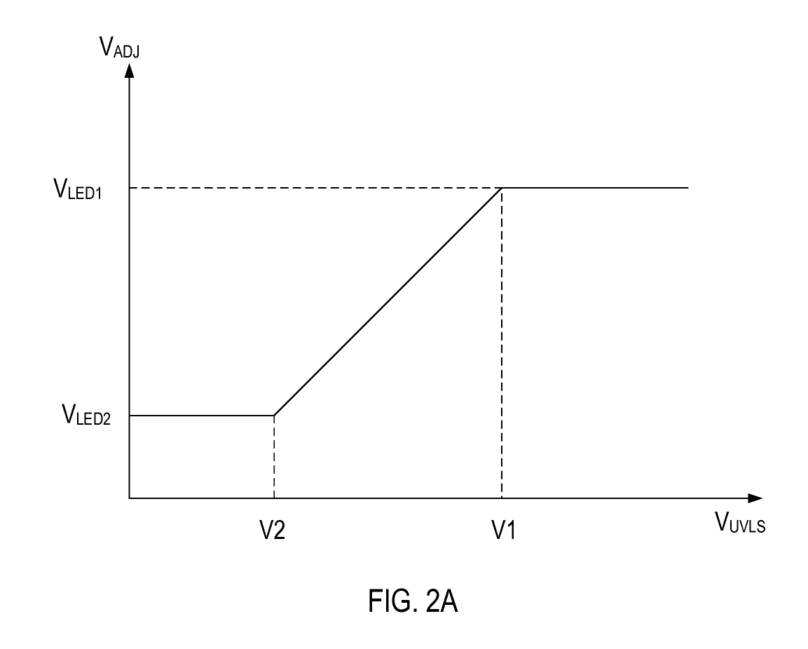

FIG. 2 illustrates a diagram of an example of a power system 200, in accordance with one embodiment of the present invention. In the example of FIG. 2, the power system 200 includes a first power source, e.g., an adapter 202, a second power source, e.g., a battery 210, switches 203, 205 and 207, a controller 206, and a load, e.g., a light-emitting diode (LED) light source 208. The adapter 202 can receive an AC voltage or a DC voltage and provide an output DC voltage V_{AD}. In one embodiment, the power system 200 selectively operates in a charging mode and a load-powering mode. The controller 206 coupled to the adapter 202 and the battery 210 compares the voltage V_{AD} of the adapter 202 with a voltage V_{BAT} of the battery 210. The controller 206 controls the adapter 202 to charge the battery 210 via the switches 203 and 207 in the charging mode when the voltage V_{AD} of the adapter 202 is greater than the voltage V_{BAT} of the battery 210. More specifically, in the charging mode, the controller 206 turns off the switch 205 and alternately turns on the switches 203 and 207 such that the adapter 202 charges the battery 210, e.g., in a constant-current phase or a constant-voltage phase according to the status of the battery 210, e.g., according to the battery voltage. The controller 206 controls the battery 210 to power the LED light source 208 via the switches 205 and 207 in the load-powering mode when the voltage V_{BAT} of the battery 210 is greater than the voltage V_{AD} of the adapter 202. More specifically, in the load-powering mode, the controller 206 turns off the switch 203 and alternately turns on the switches 205 and 207 such that the battery 210 powers the LED light source 208. The controller 206 can be integrated together with the switches 203, 205 and 207 in an integrated circuit (IC) chip 220 (referred to as the control circuit 220). Although the power system 200 is described in relation to an adapter, a battery and an LED light source for illustrative purposes, the invention is not so limited. The adapter 202 and the battery 210 can be replaced by other types of power sources and the LED light source 208 can be replaced by multiple LEDs, or other types of light sources or loads.

In one embodiment, the controller 206 includes an output terminal CTR1 to control the on/off status of the switch 203, an output terminal CTR2 to control the on/off status of the switch 205, and an output terminal CTR3 to control the on/off status of the switch 207. By way of example, the switch 203, 205 or 207, e.g., an N-channel MOSFET, is on when a control signal from the corresponding output terminal CTR1, CTR2 or CTR3 is logic high, and is off when the control signal is logic low. The controller 206 can further include an input terminal VAD to detect the voltage V_{AD} from the adapter 202, an input terminal VBAT to detect the battery voltage V_{BAT}, an input terminal ICHG cooperating with the terminal VBAT for sensing a charging current I_{CHG} from the adapter 202 to the battery 210 by monitoring a voltage V₂₁₆ across a sense resistor 216, a terminal VLED for receiving a signal indicative of a voltage V_{LED} at the anode of the LED light source 208, a terminal ILED cooperating with the terminal VLED for sensing a current I_{LED} flowing through the LED light source 208 by monitoring a voltage V₂₁₂ across a sense resistor 212, and a terminal UVLS coupled to a resistor divider 230 for receiving a voltage V_{UVLS} indicative of the battery voltage V_{BAT}, e.g., the voltage V_{UVLS} is proportional to the battery voltage V_{BAT}. In one embodiment, the controller 206 adjusts an adjustable reference voltage V_{ADJ} based on the voltage V_{UVLS}. The controller 206 can adjust the current I_{LED} flowing through the LED light source 208 according to the adjustable reference voltage V_{ADJ}. Moreover, the controller 206 can include a terminal STATUS for indicating a status of the battery 210, e.g., whether the battery 210 is fully charged or not.

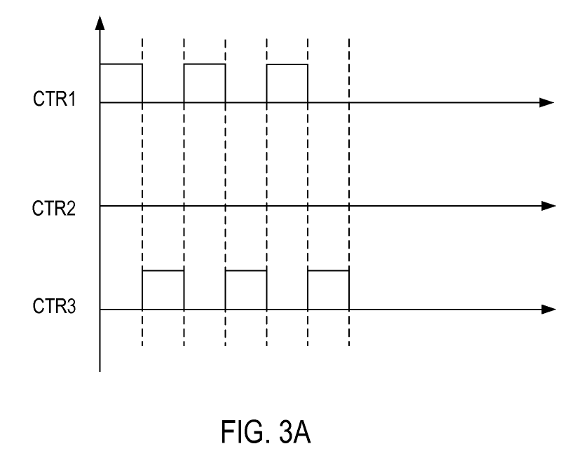

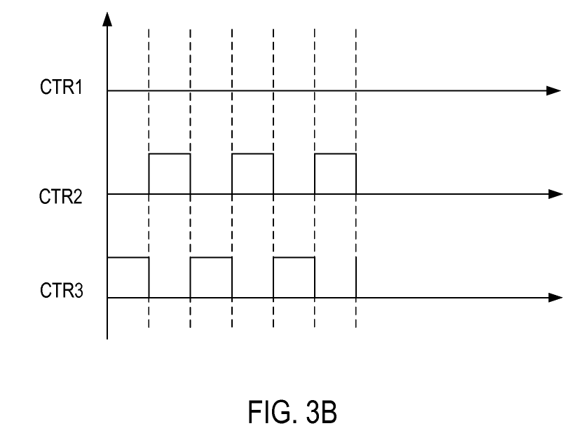

When the adapter 202 is coupled to a power source, e.g., a 120V commercial power supply, the adapter 202 converts a voltage from the power source to a DC voltage V_{AD}. The controller 206 compares the DC voltage V_{AD} with the battery voltage V_{BAT}. In one embodiment, when the DC voltage V_{AD} is greater than the battery voltage V_{BAT} and the battery 210 is not fully charged, e.g., the battery voltage V_{BAT} is less than a threshold, the power system 200 operates in the charging mode. FIG. 3A shows a timing diagram of examples of control signals from the output terminals CTR1, CTR2 and CTR3 in the charging mode. In the example of FIG. 3A, the control signals from the output terminals CTR1 and CTR3 are non-overlapping pulse signals, e.g., pulse-width modulation signals, to turn the switches 203 and 207 on alternately. The control signal from the output terminal CTR2 remains at logic low to turn off the switch 205.

Referring back to FIG. 2, in the charging mode, switches 203 and 207, an inductor 214 and a capacitor 213 operate as a buck converter to charge the battery 210, in one embodiment. More specifically, when the switch 203 is on and the switch 207 is off, the adapter 202 charges the battery 210 via the inductor 214. Meanwhile, the inductor 214 stores energy. When the switch 203 is off and the switch 207 is on, the inductor 214 is discharged to provide charging power to the battery 210.

In one embodiment, the controller 206 monitors the battery voltage V_{BAT} and a charging current of the battery 210 to control the charging process of the battery 210. More specifically, the controller 206 compares the battery voltage V_{BAT} with a predetermined threshold V_{TH} and controls a duty cycle of the switch 203 to adjust charging power from the adapter 202 to the battery 210 in the charging mode. When the battery voltage V_{BAT} is less than the predetermined threshold V_{TH}, the controller 206 controls the switch 203 and the switch 207 to charge the battery 210 in the constant-current phase, in which a substantially constant current is used to charge the battery 210. For example, when the voltage V₂₁₆ across the sense resistor 216 is greater than a reference voltage V_{BATREF}, e.g., the charging current I_{CHG} is greater than a predetermined charging current I_{BATREF}, the controller 206 decreases the charging current I_{CHG} by decreasing the duty cycle of the switch 203; when the voltage V₂₁₆ across the sense resistor 216 is less than the reference voltage V_{BATREF}, e.g., the charging current I_{CHG} is less than the predetermined charging current I_{BATREF}, the controller 206 increases the charging current I_{CHG} by increasing the duty cycle of the switch 203. If, however, the battery voltage V_{BAT} increases to the predetermined threshold V_{TH}, the controller 206 controls the switch 203 and the switch 207 to charge the battery 210 in the constant-voltage phase, in which the charging voltage is maintained at the predetermined threshold V_{TH}, in one embodiment.

The controller 206 can also monitor parameters, e.g., a voltage, temperature and a current, of the battery 210 to determine if an abnormal or undesired condition occurs. In one embodiment, the controller 206 compares the sensed battery voltage V_{BAT} with an over-voltage threshold V_{OV} to determine if an over-voltage condition occurs. If the sensed battery voltage V_{BAT} is greater than the over-voltage threshold V_{OV}, the controller 206 turns off the switch 203 and the switch 207 to terminate charging of the battery 210, in one embodiment.

The controller 206 can also compare a signal, e.g., the voltage V₂₁₆ across the resistor 216, indicative of the charging current I_{CHG}, with a predetermined threshold V_{OC} representative of an over-charging current I_{OC} to determine if an over-current condition occurs. If the voltage V₂₁₆ across the resistor 216 is greater than the predetermined threshold representative the over-charging current I_{OC}, the controller 206 turns off the switches 203 and 207 to terminate charging of the battery 210, in one embodiment.

The controller 206 can also compare a signal from a thermistor (not shown in FIG. 2) with an over-temperature threshold V_{OT} to determine if an over-temperature condition occurs. If the sensed signal is greater than the predetermined threshold V_{OT}, the controller 206 turns off the switches 203 and 207 to terminate charging of the battery 210, in one embodiment.

In the charging mode, the controller 206 can detect the battery resistance R_{BAT} according to the battery voltage V_{BAT} and the charging current I_{CHG}, as shown in equation (1):

R_{BAT}=V_{BAT/}I_{CHG}. (1)

The controller 206 can thus determine the battery type based on the battery resistance R_{BAT}. If the battery type determined by the controller 206 is a non-rechargeable battery, e.g., alkaline battery, the controller 206 terminates charging of the batter 210 to protect the battery 210 and the power system 200.

In addition, the power system 200 can operate in the load-powering mode. FIG. 3B shows a timing diagram of examples of the control signals from the output terminals CTR1, CTR2 and CTR3 in the load-powering mode. As shown in FIG. 3B, the control signals from the output terminals CTR2 and CTR3 are non-overlapping pulse signals, e.g., pulse-width modulation signals, to turn on the switches 205 and 207 alternately. The control signal from the output terminal CTR1 remains at logic low to turn off the switch 203.

In the load-powering mode, the switches 205 and 207, the inductor 214, and capacitors 211 and 213 can operate as a buck-boost converter to power the LED light source 208. More specifically, when the switch 207 is on and the switch 205 is off, the battery 210 charges the inductor 214. When the switch 207 is off and the switch 205 is on, the battery 210 together with the inductor 214 provides power to the LED light source 208. In one such embodiment, by turning on the switches 205 and 207 alternately with an adjustable duty cycle, a voltage V₁ that is greater than the battery voltage V_{BAT} is generated at a terminal of the LED light source 208. Thus, the voltage V₂₀₈ across LED light source 208 is equal to a voltage V₁ minus the battery voltage V_{BAT}. In one embodiment, by the operation of the buck-boost converter, the voltage V₂₀₈ can be adjusted to be greater than the battery voltage V_{BAT} or less than the battery voltage V_{BAT}. As such, the power system 200 can power various types and numbers of load and thus the flexibility of the power system 200 is enhanced.

In one embodiment, the controller 206 monitors the current I_{LED} flowing though the LED light source 208 via the terminals VLED and ILED, and controls a duty cycle of the switch 207 to adjust the current I_{LED} according to the adjustable reference voltage V_{ADJ}. FIG. 2A shows an example of a diagram showing a relationship between the adjustable reference voltage V_{ADJ} and the voltage V_{UVLS} of the power system 200 in FIG. 2, in accordance with one embodiment of the present invention. When the voltage V_{UVLS} is greater than a first threshold V1, the controller 206 adjusts the adjustable reference voltage V_{ADJ}, to a first constant voltage level V_{LED1}. Thus, the controller 206 adjusts the current I_{LED} through the LED light source 208 to a first predetermined current I_{LEDREF1}. When the voltage V_{UVLS} is less than a second threshold V2, the controller 206 adjusts the adjustable reference voltage V_{ADJ} to a second constant voltage level V_{LED2}. Thus, the controller 206 adjusts the current I_{LED} through the LED light source 208 to a second predetermined current I_{LEDREF2}. When the voltage V_{UVLS} is less than the first threshold V1 but greater than the second threshold V2, the controller 206 adjusts the adjustable reference voltage V_{ADJ} to vary according to the voltage U_{UVLS}. In one embodiment, the adjustable reference voltage V_{ADJ} varies linearly with the voltage U_{UVLS}. Because the voltage U_{UVLS} is proportional to the battery voltage V_{BAT}, the adjustable reference voltage V_{ADJ} varies linearly with the battery voltage V_{BAT}. As such, the controller 206 regulates the current I_{LED} to vary linearly according to the battery voltage V_{BAT}. Advantageously, the battery running time can be extended, thereby extending the operation time of LED light source.

Returning back to FIG. 2, the controller 206 compares a signal indicative of the current I_{LED}, e.g., the voltage V₂₁₂ across the resistor 212, with the adjustable reference voltage V_{ADJ}, and controls the switches 205 and 207 according to the comparison. If the voltage V₂₁₂ is greater than the adjustable reference voltage V_{ADJ}, e.g., the current I_{LED} increases, the controller 206 decreases the duty cycle of the switch 207, thereby decreasing the current I_{LED}.

If the voltage V₂₁₂ is less than the adjustable reference voltage V_{ADJ}, e.g., the current I_{LED} decreases, the controller 206 increases the duty cycle of the switch 207 to increase the current I_{LED}. As a result, the current I_{LED} flowing through the LED light source 208 is adjusted according to the adjustable reference voltage V_{ADJ} as described in relation to FIG. 2A.

Advantageously, because the switches 203, 205 and 207, the inductor 214, and the capacitors 211 and 213 can operate as a buck converter and a buck-boost converter in the charging mode and the load-powering mode, the flexibility of the power system 200 is improved. The power system 200 can support various types of loads and power sources. Moreover, the two power chains, e.g., the charger 106 and the converter 104, in the conventional power system 100 are replaced by one power chain, e.g., the converter that includes the control circuit 220. Accordingly, the power consumption of the power system 200 decreases. The complexity of the power system 200 decreases, which enhances the reliability of the power system 200. In addition, the size of the PCB and the cost of the power system 200 are reduced.

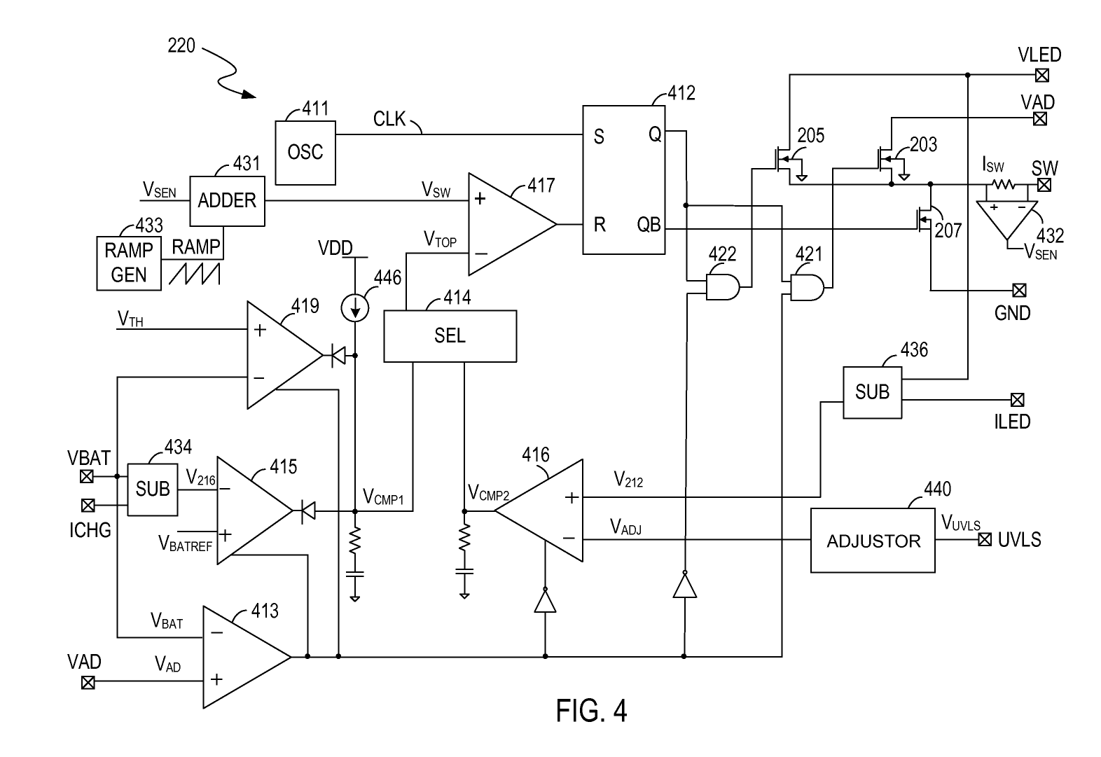

FIG. 4 illustrates a diagram of an example of a control circuit 220 in the power system 200 in FIG. 2 according to one embodiment of the present invention. FIG. 4 is described in combination with FIG. 2. In the example of FIG. 4, the control circuit 220 includes an oscillator 411, comparators 413 and 417, error amplifiers 415, 416 and 419, a selector 414, a flip-flop 412, AND gates 421 and 422, switches 203, 205 and 207, an adder 431, an amplifier 432, a ramp signal generator 433, subtractors 434 and 436, and a voltage adjustor 440.

In one embodiment, the comparator 413 compares the battery voltage V_{BAT} at the terminal VBAT with the DC voltage V_{AD} at the terminal VAD and generates a comparison signal to enable or disable the error amplifiers 415, 416 and 419. A negative terminal of a current source 446, an output of the error amplifier 415 and an output of the error amplifier 419 are coupled to a common node, in one embodiment. In one such embodiment, the error amplifier 415 and the error amplifier 419 are OR-tied together. In one embodiment, the comparator 413 enables the error amplifiers 415 and 419 in the charging mode when the DC voltage V_{AD} is greater than the battery voltage V_{BAT}, and enables the error amplifier 416 in the load-powering mode when the DC voltage V_{AD} is less than the battery voltage V_{BAT}. The error amplifier 415, when enabled, compares a signal indicative of the charging current to the battery 210, e.g., a signal from the subtractor 434 representative of the voltage V₂₁₆ across the resistor 216, with a reference voltage signal V_{BATREF}, and controls an output voltage V_{CMP1} at the common node according to the comparison. The error amplifier 419, when enabled, compares the battery voltage V_{BAT} with the predetermined threshold V_{TH}, and controls the output voltage V_{CMP1} at the common node according to the comparison. The error amplifier 416, when enabled, compares a signal indicative of the current through the LED light source 208, e.g., a signal from the subtractor 436 representative of the voltage V₂₁₂ across the resistor 212, with an adjustable reference voltage signal V_{ADJ} and controls an output voltage V_{CMP2} according to the comparison. The selector 414, coupled to the error amplifiers 415, 419 and 416, selects an output voltage from the output voltages V_{CMP1} and V_{CMP2} and outputs the selected output voltage as an output voltage V_{TOP}, in one embodiment. More specifically, when the error amplifiers 415 and 419 are enabled by the comparator 413, e.g., when the DC voltage V_{AD} is greater than the battery voltage V_{BAT}, the selector 414 selects the output voltage V_{CMP1}. When the error amplifier 416 is enabled by the comparator 413, e.g., when the DC voltage V_{AD} is less than the battery voltage V_{BAT}, the selector 414 selects the output voltage V_{CMP2}. The output voltage V_{TOP} is received by the comparator 417.

An input of the adder 431 is coupled to the amplifier 432 to receive a signal V_{SEN} representative of a current I_{SW} flowing through the inductor 214, and another input of the adder 431 is coupled to the ramp generator 433 to receive a ramp signal RAMP, in the example of FIG. 4. As a result, the output V_{SW} of the adder 431 is the summation of the signal V_{SEN} and the signal RAMP. The comparator 417 compares the signal V_{SW} output by the adder 431 with the output voltage V_{TOP} of the selector 414, and provides an output to the terminal R of the flip-flop 412 to control the switches 203, 205 and 207. The terminal S of the flip-flop 412 is coupled to the oscillator 411 to receive a clock signal CLK. For example, the clock signal CLK has a frequency of 1 MHz. The inverting output terminal QB of the flip-flop 412 controls the switch 207. In addition, the non-inverting output terminal Q of the flip-flop 412 cooperates with the comparator 417 to control the switches 203 and 205 via the AND gates 421 and 422.

During operation, when the DC voltage V_{AD} is greater than the battery voltage V_{BAT,} the output of the comparator 413 is in a first state, e.g., logic high, thereby enabling the power system 200 to operate in the charging mode in which the error amplifiers 415 and 419 are enabled while the error amplifier 416 is disabled. In the charging mode, the AND gate 422 controls the switch 205 to be turned off. The flip-flop 412, together with the AND gate 421, alternately turns on the switches 203 and 207. The flip-flop 412 further controls the duty cycles of the switches 203 and 207 according to a comparison of the signal V_{SW} with the output voltage V_{TOP} from the selector 414 to control the charging power to the battery 210.

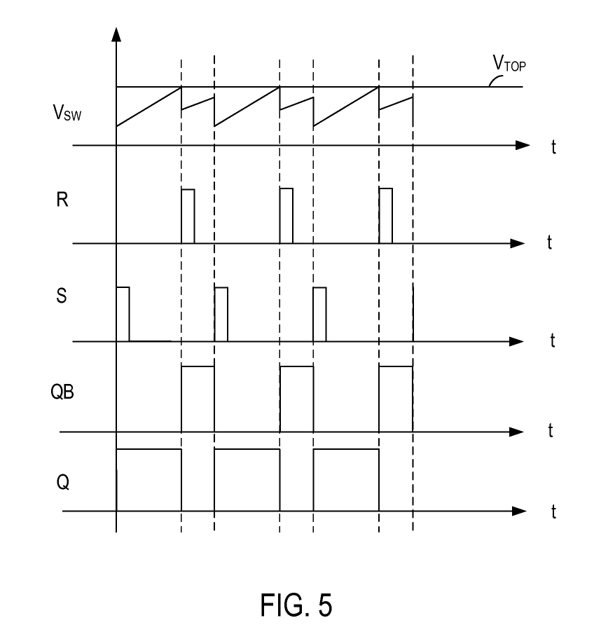

More specifically, in the charging mode, when the battery voltage V_{BAT} is less than the predetermined threshold V_{TH}, the control circuit 220 controls the switches 203 and 207 to charge the battery 210 in a constant-current phase, in one embodiment. The error amplifier 415 compares a signal indicative of the charging current to the battery 210, e.g., voltage V₂₁₆ across the resistor 216, with the reference voltage signal V_{BATREF}, and controls the output voltage V_{CMP1}. The selector 414 selects the output voltage V_{CMP1} as the output voltage V_{TOP}. As such, the flip-flop 412 controls the duty cycles of the switches 203 and 207 according to a comparison of the selected output voltage V_{TOP} with the signal V_{SW}. FIG. 5 illustrates a timing diagram of examples of signals associated with the flip-flop 412. When the voltage V₂₁₆ is less than the reference voltage V_{BATREF}, e.g., the charging current I_{CHG} is less than a predetermined charging current I_{BATREF}, the output voltage V_{CMP1} increases. Thus, the output voltage V_{TOP} increases. As a result, the duty cycle of the switch 203 increases, and the charging current I_{CHG} of the battery 210 increases accordingly. When the voltage V₂₁₆ is greater than the reference voltage V_{BATREF}, e.g., the charging current I_{CHG} is greater than the predetermined charging current I_{BATREF,} the output voltage V_{CMP1} decreases. Thus, the output voltage V_{TOP} decreases. As a result, the duty cycle of the switch 203 decreases, and the charging current I_{CHG} of the battery 210 decreases accordingly. Therefore, the charging current I_{CHG} is adjusted to the predetermined charging current I_{BATREF} in the constant-current phase.

When the battery voltage V_{BAT} reaches the predetermined threshold V_{TH}, the control circuit 220 can control the switches 203 and 207 to charge the battery 210 in a constant-voltage phase. In the constant-voltage phase, the error amplifier 419 compares the battery voltage V_{BAT} with the predetermined threshold V_{TH}, and controls the output voltage V_{CMP1}. For example, when the battery voltage V_{BAT} is greater than the predetermined threshold V_{TH}, the output voltage V_{CMP1} decreases. Thus, the output voltage V_{TOP} decreases accordingly. As a result, the duty cycle of the switch 203 decreases, and the charging voltage of the battery 210 decreases accordingly. Therefore, the charging voltage is adjusted to the predetermined threshold V_{TH} in the constant-voltage phase.

When the DC voltage V_{AD} is less than the battery voltage V_{BAT}, the output of the comparator 413 is in a second state, e.g., logic low, thereby enabling the power system 200 to operate in the load-powering mode in which the error amplifiers 415 and 419 are disabled while the error amplifier 416 is enabled. In the load-powering mode, the switch 203 is turned off by the AND gate 421. The flip-flop 412, together with the AND gate 422, alternately turns on the switches 205 and 207. The flip-flop 412 further controls the duty cycles of the switches 205 and 207 according to a comparison of the signal V_{SW} with the output voltage V_{TOP} from the selector 414 to control the current I_{LED} through the LED light source 208.

More specifically, in the load-powering mode, the error amplifier 416 compares a signal indicative of the current through the LED light source 208, e.g., the voltage V₂₁₂ across the resistor 212, with the adjustable reference voltage signal V_{ADJ} adjusted by the voltage adjustor 440 based on the voltage V_{UVLS}. In one embodiment, the voltage V_{UVLS} is indicative of the battery voltage V_{BAT}, e.g., proportional to the battery voltage V_{BAT}. When the voltage V_{UVLS} is greater than a first threshold V1, the adjustor 440 adjusts the adjustable reference voltage V_{ADJ} to a first constant voltage level V_{LED1}. When the voltage V_{UVLS} is less than a second threshold V2, the adjustor 440 adjusts the adjustable reference voltage V_{ADJ} to a second constant voltage level V_{LED2}. When the voltage V_{UVLS} is less than the first threshold V1 but greater than the second threshold V2, the adjustor 440 adjusts the adjustable reference voltage V_{ADJ} to vary linearly according to the voltage V_{UVLS}. Because the voltage V_{UVLS} is proportional to the battery voltage V_{BAT}, the adjustable reference voltage V_{ADJ} varies linearly according to the battery voltage V_{BAT}.

The error amplifier 416 controls the output voltage V_{CMP2} according to the comparison of voltage V₂₁₂ across the resistor 212 with the adjustable reference voltage signal V_{ADJ}. The selector 414 selects the output voltage V_{CMP2} as the output voltage V_{TOP}. As such, the flip-flop 412 controls the duty cycles of the switches 205 and 207 according to a comparison of the selected output voltage V_{TOP} with the signal V_{SW}. FIG. 5 illustrates a timing diagram of examples of signals associated with the flip-flop 412. When the voltage V₂₁₂ is less than the adjustable reference voltage V_{ADJ}, e.g., the current I_{LED} through the LED light source 208 decreases, the output voltage V_{CMP2} decreases and the output voltage V_{TOP} decreases accordingly. As a result, the duty cycle of the switch 207 increases, and the current I_{LED} increases accordingly. When the voltage V₂₁₂ is greater than the adjustable reference voltage V_{ADA}, e.g., the current I_{LED} increases, the output voltage CMP2 increases and the output voltage V_{TOP} increases accordingly. As a result, the duty cycle of the switch 207 decreases, and the current I_{LED} decreases accordingly. Therefore, the current I_{LED} through the LED light source 208 is adjusted according to the adjustable reference voltage V_{ADJ}. Therefore, the current I_{LED} is adjusted to a first predetermined current I_{LEDREF1} when the voltage V_{UVLS} is greater than a first threshold V1 and a second predetermined current I_{LEDREF2} when the voltage V_{UVLS} is less than the second threshold V2. The current I_{LED} can also be adjusted to vary linearly according to the battery voltage V_{BAT} when the voltage V_{UVLS} is greater than the second threshold V2 but less than the first threshold V1.

The control circuit 220 can further protect the power system 200 by terminating charging of the battery when an abnormal or undesired condition occurs, e.g., an over-current condition, an over-voltage condition, and an over-temperature condition. In one embodiment, the control circuit 220 can include a comparator (not shown in FIG. 4) to compare the battery voltage V_{BAT} with an over-voltage threshold V_{OV} to determine if an over-voltage condition occurs. The control circuit 220 can include a comparator (not shown in FIG. 4) to compare the voltage V₂₁₆ across the resistor 216 with a predetermined threshold representative of an over-charging current I_{OC} to determine if an over-current condition occurs. The control circuit 220 can further include a comparator (not shown in FIG. 4) to compare a signal from a thermistor (not shown in FIG. 4) with an over-temperature threshold V_{OT} to determine if an over-temperature condition occurs. If any of the abnormal conditions occurs, the control circuit 220 turns off the switches 203 and 207 to terminate charging of the battery 210 to protect the power system 200.

The control circuit 220 can further detect the type of the battery 210 and terminate charging the battery 210 if the battery is a non-rechargeable battery, e.g., alkaline battery. As such, the control circuit 220 protects the battery 210 and the power system 200.

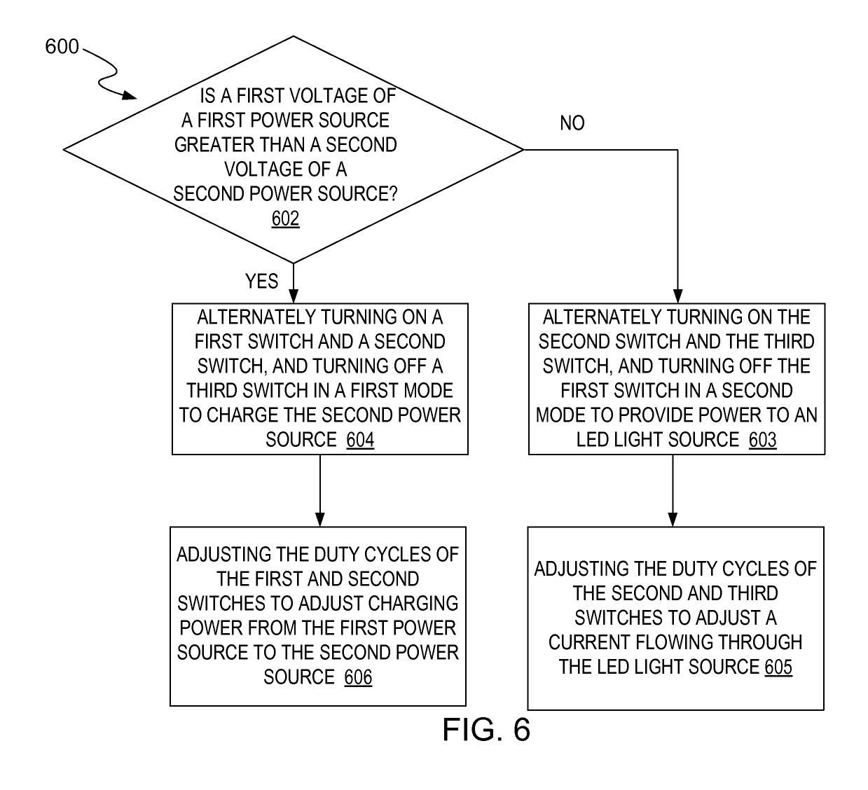

FIG. 6 illustrates a flowchart of operations 600 performed by a power system, in accordance with one embodiment of the present invention. FIG. 6 is described in combination with FIG. 2 and FIG. 4.

In block 602, a power system, e.g., the power system 200, compares a first voltage of a first power source with a second voltage of a second power source, e.g., a battery. When the first voltage of the first power source is greater than the second voltage of the second power source, the power system 200 can operate in a first mode, e.g., a charging mode. When the first voltage of the first power source is less than the second voltage of the second power source, the power system 200 can operate in a second mode, e.g., a load-powering mode.

If the power system 200 operates in the charging mode, the flowchart goes to block 604. In block 604, the power system 200 alternately turns on a first switch 203 and a second switch 207 to charge the second power source, e.g., a battery 210, and turns off a third switch 205. In block 606, the power system 200 adjusts the duty cycles of the first switch 203 and the second switch 207 to adjust charging power from the first power source to the second power source.

More specifically, when the voltage of the second power source, e.g., the battery voltage V_{BAT}, is less than a predetermined threshold V_{TH}, the power system 200 charges the second power source in a constant-current phase. In the constant-current phase, the power system 200 compares the charging current I_{CHG} with a predetermined charging current I_{BATREF}. When the charging current I_{CHG} is greater than the predetermined charging current I_{BATREF}, the power system 200 decreases the duty cycle of the first switch 203 to decrease the charging current I_{CHG}. When the charging current I_{CHG} is less than the predetermined charging current I_{BATREF}, the power system 200 increases the duty cycle of the first switch 203 to increase the charging current I_{CHG}. Therefore, the charging current I_{CHG} is adjusted to the predetermined charging current I_{BATREF}.

When the voltage of the second power source, e.g., the battery voltage V_{BAT}, reaches the predetermined threshold V_{TH}, the power system 200 charges the second power source in a constant-voltage phase. In the constant-voltage phase, the power system 200 compares the battery voltage V_{BAT} with the predetermined threshold V_{TH}, and controls the duty cycles of the switches 203 and 207 such that the charging voltage is adjusted to the predetermined threshold V_{TH}. Therefore, the second power source is charged in the constant-voltage phase.

If the power system 200 operates in the load-powering mode, the flowchart goes to block 603. In block 603, the power system 200 turns off a first switch 203 and alternately turns on the second switch 207 and the third switch 205 to provide power to a load, e.g., an LED light source 208. In block 605, the power system 200 adjusts the duty cycles of the second and third switches 207 and 205 according to the comparison of the current I_{LED} flowing through the LED light source 208 with an adjustable reference current I_{ADJ}. In one embodiment, the adjustable reference current I_{ADJ} is adjusted based a voltage V_{UVLS} proportional to the battery voltage V_{BAT}. The adjustable reference current I_{ADJ} is adjusted to a first predetermined current I_{LEDREF1} when the voltage V_{UVLS} is greater than a first threshold V1. The adjustable reference current I_{ADJ} is adjusted to a second predetermined current I_{LEDREF2} when the voltage V_{UVLS} is less than a second threshold V2. The adjustable reference current I_{ADJ} is adjusted to vary linearly with the voltage V_{UVLS} and the battery voltage V_{BAT} when the voltage V_{UVLS} is less than the first threshold V1 but greater than the second threshold V2.

When the current I_{LED} is greater than the adjustable reference current I_{ADJ}, the power system 200 decreases the duty cycle of the second switch 207 to decrease the current I_{LED} flowing through the LED light source 208. When the current I_{LED} is less than the adjustable reference current I_{ADJ}, the power system 200 increases the duty cycle of the second switch 207 to increase the current I_{LED}. Therefore, the current I_{LED} is adjusted according to the adjustable reference current I_{ADJ}. Therefore, the current I_{LED} is adjusted to the first predetermined current I_{LEDREF1} when the voltage V_{UVLS} is greater than the first threshold V1 and is adjusted to the second predetermined current I_{LEDREF2} when the voltage V_{UVLS} is less than the second threshold V2. The current I_{LED} can also be adjusted to vary linearly with the battery voltage V_{BAT} when the voltage V_{UVLS} is greater than the second threshold V2 but less than the first threshold V1.

While the foregoing description and drawings represent embodiments of the present invention, it will be understood that various additions, modifications and substitutions may be made therein without departing from the spirit and scope of the principles of the present invention. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, and not limited to the foregoing description.

What is claimed is:

1. A system for powering a light-emitting diode (LED) light source, comprising:
a first power source with a first voltage;
a second power source with a second voltage;
a controller coupled to said first power source and said second power source, and for comparing said first voltage with said second voltage, controlling said first power source to charge said second power source via a first switch and a second switch in a charging mode when said first voltage is greater than said second voltage, and controlling said second power source to power said LED light source via said second switch and a third switch in a load-powering mode when said second voltage is greater than said first voltage.

2. The system as claimed in claim 1, wherein said controller turns off said third switch and alternately turns on said first switch and said second switch in said charging mode.

3. The system as claimed in claim 1, wherein said first power source charges said second power source in a constant-current phase when said second voltage is less than a predetermined threshold, and wherein said first power source charges said second power source in a constant-voltage phase when said second voltage reaches said predetermined threshold.

4. The system as claimed in claim 1, wherein said controller controls a duty cycle of said first switch to adjust charging power to said second power source in said charging mode.

5. The system as claimed in claim 1, wherein said controller turns off said first switch and alternately turns on said second switch and said third switch in said load-powering mode.

6. The system as claimed in claim 1, wherein said controller controls a duty cycle of said second switch to adjust a current flowing through said LED light source according to an adjustable reference voltage, wherein said adjustable reference voltage is adjusted according to a third voltage indicative of said second voltage, and wherein said current flowing through said LED light source varies according to said second voltage when said third voltage is less than a first threshold but greater than a second threshold.

7. The system as claimed in claim 1, wherein said second power source comprises a battery, and wherein said controller determines a battery type of said battery based on a battery resistance of said battery, and terminates charging of said battery if said battery is a non-rechargeable battery.

8. A control circuit for controlling power to a light-emitting diode (LED) light source, comprising:
a first switch;
a second switch coupled to said first switch;
a third switch coupled between said first switch and said second switch; and
a controller coupled to said first switch, said second switch and said third switch for comparing a first voltage of a first power source with a second voltage of a second power source,
wherein said controller controls said first power source to charge said second power source via said first switch and said second switch in a charging mode when said first voltage is greater than said second voltage, and controls said second power source to power said LED light source via said second switch and said third switch in a load-powering mode when said second voltage is greater than said first voltage.

9. The control circuit as claimed in claim 8, wherein said controller turns off said third switch and alternately turns on said first switch and said second switch in said charging mode, and wherein said controller turns off said first switch and alternately turns on said second switch and said third switch in said load-powering mode.

10. The control circuit as claimed in claim 8, wherein said controller comprises:
a first error amplifier for comparing a first signal indicative of a charging current from said first power source to said second power source with a first reference signal; and
a second error amplifier, coupled to said first error amplifier at a common node, for comparing said second voltage with a first predetermined threshold,
wherein said first error amplifier and said second error amplifier are enabled in said charging mode to control a first output voltage at said command node.

11. The control circuit as claimed in claim 10, wherein said controller further comprises:
a third error amplifier for controlling a second output voltage according to a comparison of a second signal indicative of a current through said LED light source with an adjustable reference signal,
wherein said third error amplifier is enabled in said load-powering mode.

12. The control circuit as claimed in claim 11, wherein said controller further comprises:
a selector coupled to said first error amplifier, said second error amplifier and said third error amplifier for selecting a voltage from said first output voltage and said second output voltage; and
a first comparator for receiving said selected voltage from said selector, and for comparing said selected voltage with a third signal.

13. The control circuit as claimed in claim 12, wherein said controller adjusts a duty cycle of said first switch in said charging mode according to a comparison of said selected voltage with said third signal.

14. The control circuit as claimed in claim 12, wherein said controller adjusts a duty cycle of said second switch in said load-powering mode according to a comparison of said selected voltage with said third signal.

15. The control circuit as claimed in claim 12, wherein said third signal indicates a current flowing through an inductor coupled between said first switch and said second switch, wherein said inductor, together with said first switch and said second switch, operates as a first converter in said charging mode, and wherein said inductor, together with said second switch and said third switch, operates as a second converter in said load-powering mode.

16. The control circuit as claimed in claim 9, wherein said second power source comprises a battery, and wherein said controller determines a battery type of said battery based on a battery resistance of said battery, and terminates charging of said battery if said battery is a non-rechargeable battery.

17. A method for powering a light-emitting diode (LED) light source, comprising:
comparing a first voltage of a first power source with a second voltage of a second power source;
alternately turning on a first switch and a second switch, and turning off a third switch in a first mode when said first voltage is greater than said second voltage, wherein said first power source charges said second power source via said first switch and said second switch in said first mode; and
alternately turning on said second switch and said third switch, and turning off said first switch in a second mode, wherein said second power source powers said LED light source via said second switch and said third switch in said second mode.

18. The method as claimed in claim 17, further comprising:
adjusting a duty cycle of said first switch to adjust charging power from said first power source to said second power source in said first mode.

19. The method as claimed in claim 17, further comprising:
adjusting a duty cycle of said second switch to adjust a current flowing through said LED light source according to an adjustable reference current,
wherein said adjustable reference current is adjusted based on a third voltage indicative of said second voltage, and wherein said current flowing through said LED light source varies according to said second voltage when said third voltage is less than a first threshold but greater than a second threshold.

20. The method as claimed in claim 17, wherein said first switch and said second switch, together with an inductor, operate as a first converter in said first mode, and wherein said second switch and said third switch, together with said inductor, operate as a second converter in said second mode.
